(19) United States
(12) Patent Application Publication
(10) Pub. No.: US 2013/0188287 A1
(43) Pub. Date: Jul. 25, 2013

(54) PROTECTION CIRCUIT, CHARGE CONTROL CIRCUIT, AND REVERSE CURRENT PREVENTION METHOD EMPLOYING CHARGE CONTROL CIRCUIT

(71) Applicant: Masayuki Imura, Osaka (JP)

(72) Inventor: Masayuki Imura, Osaka (JP)

(73) Assignee: RICOH COMPANY, LTD., Tokyo (JP)

(21) Appl. No.: 13/748,666

(22) Filed: Jan. 24, 2013

(30) Foreign Application Priority Data
Jan. 25, 2012 (JP) 2012-013076

(51) Int. Cl. H02H 3/18

(52) U.S. Cl. CPC H02H 3/18
USPC 361/56; 361/93.9

(57) ABSTRACT

A protection circuit to protect from a reverse current, including a current limitation element to connect between an external reference terminal and an internal reference potential to limit the amount of current flowing from the external reference terminal to a power source terminal, when a reversed polarity voltage is applied at the power source terminal; and a conducting element to connect between the power source terminal and the internal reference potential to adjust the internal reference potential to the voltage at the power source terminal, when the reversed polarity voltage is applied.

### CROSS-REFERENCE TO RELATED APPLICATION

This patent application is based on and claims priority pursuant to 35 U.S.C. §119 to Japanese Patent Application No. 2012-013076, filed on Jan. 25, 2012 in the Japan Patent Office, the entire disclosure of which is hereby incorporated by reference herein.

### BACKGROUND

1. Technical Field

The present disclosure relates to a protection circuit to protect a circuit from application of a reversed polarity voltage, a charge control circuit including a protection circuit that prevents a reverse current in the charge control circuit caused by applying the reversed polarity voltage, and a reverse current prevention method employing the charge control circuit.

2. Description of the Related Art

A related-art charge control circuit includes an external reference terminal, a power source terminal, and an output terminal to output a current generated based on a voltage applied between the power source terminal and the external reference terminal. In such a charge control circuit, the power source terminal is connected to an adapter or to a universal serial bus (USB) terminal of a personal computer and the output terminal is connected to a charging circuit such as charge control integrated circuit (IC) or a lithium-ion battery.

Typically, the charge control circuit includes an overvoltage detection circuit that turns an internal driver off to break the circuit between the power source terminal and the output terminal, thereby protecting a connected later-stage charging control IC or lithium-ion battery from overvoltage. FIG. 1 is a circuit diagram illustrating a configuration of such a charge control circuit 10-x, and the problem with the charging control circuit shown in FIG. 1 is described below with reference thereto.

In the charge control circuit 10-x shown in FIG. 1, by applying at a power source terminal VIN, a high voltage (straight polarity voltage) that is higher than the potential at an external reference terminal GND, charging can be performed normally.

However, in the charge control circuit, due to the failure of the adapter, when a low voltage (reversed polarity voltage) lower than the potential at the external reference terminal GND is applied at the power source terminal VIN, a current flows from the base of a parasitic npn-type bipolar transistor P2 formed in an N-channel MOS transistor (internal driver transistor) M10 to the emitter thereof, which turns the parasitic npn-type bipolar transistor P2 on. As the parasitic npn-type bipolar transistor P2 is switched on, a large reverse current flows from the output terminal VOUT to the power source terminal VIN through the collector and emitter of the parasitic npn-type bipolar transistor P2.

At the same time, when the reversed polarity voltage is applied to the charge control circuit 10-x, a forward direction bias is applied to a parasitic diode P1 formed in an electrostatic protection circuit 12. Therefore, a large current flows from the external reference terminal GND to the power source terminal VIN through the parasitic diode P1.

As described above, by generating a large reverse current when the reversed polarity voltage is applied, the charge control circuit 10-x or a subsequent stage of the circuit such as a charging circuit or a battery is overheated, causing a malfunction.

In order to correspond to reversed polarity voltage, in JP-2009-100519-A, a back-flow protection transistor is provided in a previous stage of the internal driver transistor M10 (in a portion surrounded by a broken circle shown in FIG. 1), in stead of the electrostatic protection circuit, to protect the circuit 10-x from the reversed polarity voltage.

However, in this example, two transistors (the back-flow protection transistor and the internal driver transistor M10) are connected in series between the power source terminal VIN and the output terminal VOUT, therefore,total on-resistance of the transistors becomes increased. Alternatively, it is necessary to set the transistors large so as to decrease the on-resistance thereof, and accordingly, the chip size of the entire circuit becomes increased.

### SUMMARY

In one aspect of this disclosure, there is provided a novel a protection circuit that includes a current limitation element and a conducting element. The current limitation element connects between an external reference terminal and an internal reference potential, limits the amount of current flowing from the external reference terminal to a power source terminal, when a reversed polarity voltage is applied at the power source terminal. The conducting element connects between the power source terminal and the internal reference potential to adjust the internal reference potential to the potential at the power source terminal, when the reversed polarity voltage is applied.

In another aspect of this disclosure, there is provided a novel charge control circuit that includes a power source terminal, an output terminal, an external reference terminal, a driver transistor, and a protection circuit. A power source voltage is applied from an external power source to the power source terminal. The output terminal outputs a current based on the power source voltage. The external reference terminal is connected to an external reference potential. The driver transistor is connected to the power source terminal, the output terminal, and an internal reference potential. The protection circuit prevents a reverse current from flowing from the output terminal to the power source terminal. The protection circuit includes a current limitation element and a conducting element. The current limitation element connects between the external reference terminal and the internal reference potential to limit the amount of current flowing from the external reference terminal to the power source terminal, hen a reversed polarity voltage is applied at the power source terminal. The conducting element, connected between the power terminal and the internal reference potential, adjusts the internal reference potential to the voltage at the power source terminal to prevent parasitic operation of the driver transistor, when the reversed polarity voltage is applied.

In yet another aspect of this disclosure, there is provided a novel reverse current prevention method employing the charge control circuit that includes a power source terminal to which a power source voltage is applied from an external power source; an output terminal to output a current based on the power source voltage; an external reference terminal connected to an external reference potential; and a driver transistor connected between the power source terminal, the output terminal, and an internal reference potential.

The method includes the steps of applying a reverse polarity voltage, whose potential is lower than a potential at the external reference terminal, at the power source terminal; limiting the amount of current flowing from the external reference terminal to the power source terminal; detecting that the reversed polarity voltage is applied; connecting the internal reference potential with the power source terminal; dropping an internal reference potential to the potential at the power source terminal; stopping parasitic operation of the driver transistor; and preventing a reverse current from flowing from the output terminal to the power supply terminal through the driver transistor.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a circuit diagram illustrating a configuration of a conventional charge control circuit;

FIG. 2 is block diagram illustrating a charge control circuit including a protection circuit according to a first embodiment of the present disclosure;

FIG. 3 is a circuit diagram illustrating a specific configuration of a charge control circuit including a protection circuit according to a second embodiment;

FIG. 4 is a circuit diagram illustrating a specific configuration of a charge control circuit including a protection circuit according to a third embodiment; and

FIG. 5 is a circuit diagram illustrating a specific configuration of a charge control circuit including a protection circuit according to a fourth embodiment.

### DETAILED DESCRIPTION OF PREFERRED EMBODIMENTS

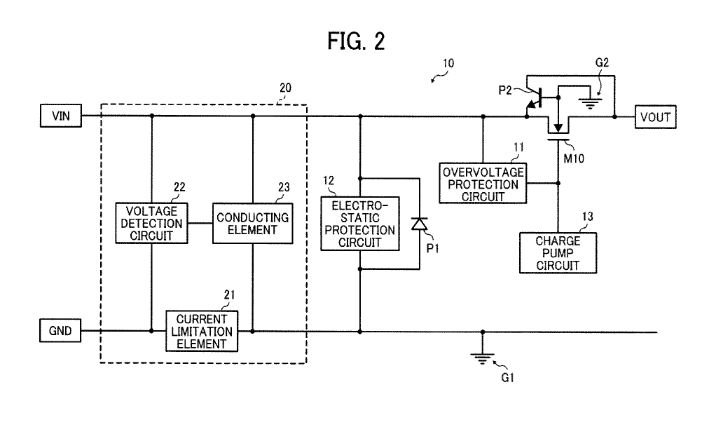

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result. Referring now to the drawings, wherein like reference numerals designate identical or corresponding parts throughout the several views thereof, and particularly to FIGS. 2 through 5, a charge control circuit according to illustrative embodiments of the present disclosure is described.

### First Embodiment

A configuration according to a first embodiment is described below with reference to FIG. 2. FIG. 2 is block diagram illustrating a charge control circuit 10 including a protection circuit 20 according to a first embodiment. The charge control circuit 10 passes an electric current from the power source terminal VIN to an output terminal VOUT to supply a current for charging a connected later-stage charge circuit or a battery.

Herein, in this disclosure, a voltage at the power source terminal VIN whose potential is higher than the potential at an external reference terminal GND is called a straight polarity voltage. Conversely, a voltage at the power source terminal VIN whose potential is lower than the potential at the external reference terminal GND is called a reversed polarity voltage.

As illustrated in FIG. 2, the charge control circuit 10 includes a negative channel (N-channel) metal-oxide semiconductor (MOS) transistor M10, an overvoltage protection circuit 11, an electrostatic protection circuit 12 that protects the entire of the charge control circuit 10 from electro-static discharge (ESD) surge, a charge pump circuit 13, and a reversed polarity voltage protection circuit 20. In the electrostatic protection circuit 12, a parasitic diode P1 is formed. In the N-channel MOS transistor M10, a parasitic npn-type bipolar transistor P2 is formed.

In FIG. 2, in terms of the N-channel MOS transistor (driver transistor) M10, a drain thereof is connected to the power source terminal VIN, a source thereof is connected to the output terminal VOUT, a gate thereof is connected to the charge pump circuit 13, and a back-gate thereof is connected to a second internal reference potential G2. The overvoltage protection circuit 11 is connected to the power source terminal VIN and the charge pump circuit 13. The electrostatic protection circuit 12 is connected between the power source terminal VIN and a first internal reference potential G1. A cathode of the parasitic diode P1 is connected to the power source terminal VIN and an anode thereof is connected to the external reference terminal GND. A base of the parasitic npn-type bipolar transistor P2 is connected to the second internal reference potential G2, a collector thereof is connected to the output terminal VOUT, and an emitter thereof is connected to the power source terminal VIN.

The reversed polarity voltage protection circuit 20, serving as a protection circuit, includes a current limitation element 21, a voltage detection circuit 22, and a conducting element 23. The current limitation element 21 is connected to the external reference terminal GND and the first internal reference potential G1. The current limitation element 21 is connected to the side close to the internal reference potential G1. The voltage detection circuit 22 is connected between the power source terminal VIN and the external reference terminal GND. The conducting element 23 is disposed between the power source terminal VIN and the first internal reference potential G1. Although figure is omitted, the first internal reference terminal (potential) G1 and the second internal reference terminal (potential) G2 are connected to each other.

The current limitation element 21 limits the amount of current flowing from the external reference terminal GND. The voltage detection circuit 22 detects that the reversed polarity voltage is applied to the charge control circuit 10, and controls the conducting element 23 based on the detection result. The conducting element 23 switches a conduction state and a non-conduction state of connection between the power source terminal VIN and the internal reference potential G1. It is to be noted that, the conducting element 23 is designed to have current driving ability higher than the current limitation element 21.

In a general charge control circuit, the power source terminal VIN and the external reference terminal GND are connected to an adapter or to a USB terminal in a personal computer. The output terminal VOUT is connected to, for example, a charge control IC, and a lithium-ion battery.

Next, operation of the charge control circuit 10 without the protection circuit 20 is described below. When the straight polarity voltage is applied to the charge control circuit 10 and the voltage is equal to or lower than a threshold voltage of an allowable range of the overvoltage protection circuit 11, the charge pump circuit 13 turns the N-channel MOS transistor M10 on, and the currents flows from the power source terminal VIN to the output terminal VOUT. This current charges the battery connected to the output terminal VOUT.

Herein, to turn the N-channel MOS transistor M10 on during charging operation, the gate voltage of the N-channel MOS transistor M10 is required to set higher than the source thereof. In order to increase the voltage at the output terminal VOUT to the voltage at the power source terminal VIN, the gate voltage of the N-channel MOS transistor M10 is required to set higher than the voltage at the power source terminal VIN. Thus, the charge pump circuit 13 applies the increased voltage to the gate of the N-channel MOS transistor M10.

On the other hand, when the voltage applied to the charge control circuit 10 is higher than the threshold voltage set in the overvoltage protection circuit 11, the overvoltage protection circuit 11 stops the operation of the charge pump circuit 13 and turns the N-channel MOS transistor M10 off.

In addition, when the straight polarity voltage is applied to the charge control circuit 10, the voltage detection circuit 22 does not detect applying the reversed polarity voltage. Based on the detection result, the conducting element 23 is rendered non-conductive, and the current does not flow through the conducting element 23.

Conversely, when the reversed polarity voltage is applied to the charge control circuit 10, the current flows from the base of the parasitic npn-type bipolar transistor P2 in the N-channel MOS transistor M10 to the emitter thereof, and accordingly, the parasitic npn-type bipolar transistor P2 is switched on. By turning the parasitic npn-type bipolar transistor P2 on, the reverse current flows from the output terminal VOUT to the power source terminal VIN through the collector and emitter of the parasitic npn-type bipolar transistor P2.

At the same time, when the reversed polarity voltage is applied to the charge control circuit 10, a forward bias (diode forward current) is applied to the parasitic diode P1 in the electrostatic protection circuit 12, and therefore, the parasitic diode P1 is turned on. By turning the parasitic diode P1 on, the reverse current flows from the external reference terminal GND to the power source terminal VIN through the parasitic diode P1.

By generating the reverse current flowing from the external reference terminal GND to the power source terminal VIN through the parasitic diode P1 and the base and emitter of the parasitic npn-type bipolar transistor P2, the internal reference potentials G1(G2) declines to a potential obtained by adding a forward voltage drop across the p-n junction to the potential at the power source terminal VIN. “Forward voltage drop across the p-n junction” is the voltage, generated in the parasitic elements P1 and P2, dropped when the forward bias is applied to the parasitic diode P1 or to the base and emitter of the parasitic npn-type bipolar transistor P2. However, in a state in which the potential at the external reference terminal GND differs from the potential at the power source terminal VIN by the forward voltage drop across the p-n junction, the parasitic diode P1 and the parasitic opts-type bipolar transistor P2 keep on states and the reverse current keeps flowing to the power source terminal VIN.

In order to prevent generation of the reverse current through the parasitic diode P1 and the parasitic npn-type bipolar transistor P2, the reversed polarity voltage protection circuit 20 of the present embodiment executes the following operation. The amount of reverse current flowing through the parasitic elements P1 and P2 are limited by the current limitation element 21.

Next, the operation of the reversed polarity voltage protection circuit 20 is described below. When the voltage detection circuit 22 detects that the reversed polarity voltage is applied, the voltage detection circuit 22 transmits the detection result to the conducting element 23. Receiving the detection result indicating that the reversed polarity voltage is applied, the conducting element 23 is rendered conductive to connect the power source terminal VIN with the internal reference potential GI, and accordingly, the potential at the power source terminal VIN and the potential at the internal reference potential G1(G2) become equal.

Although the reverse current flows from the external reference terminal GND to the power source terminal VIN through the conducting element 23 when the conducting element 23 is rendered conductive, the amount of reverse current is limited by the current limitation element 21, at this time.

The conducting element 23 adjusts the internal reference voltage potential G2 to the potential at the power source terminal VIN, and accordingly, the voltage between the base and emitter of the parasitic npn-type bipolar transistor P2 become 0 V, which switches the parasitic npn-type bipolar transistor P2 off (stop parasitic operation of the driver transistor M10). By turning the parasitic npn-type bipolar transistor P2 off, the reverse current flowing from the output terminal VOUT to the power source terminal VIN is prevented.

Along with these processes, since the internal reference potential G1 is adjusted to the potential at the power source terminal VIN, the forward bias applied to the parasitic diode P1 in the electrostatic protection circuit 12 is stopped, which prevents the reverse current from flowing from the external reference terminal GND to the power source terminal VIN through the parasitic diode P1.

As described above, in the first embodiment, when the reversed polarity voltage is applied to the charge control circuit 10, the current limitation element 21 limits the amount of reverse current, and the voltage detection circuit 22 detects that the reversed polarity voltage is applied, and renders the conducting element 23 conductive state. The conducting element 23 controls the internal reference potential G1(G2) so that the internal reference potential G1(G2) declines to the potential at the power source terminal VIN, and accordingly, the parasitic elements P1 and P2 are switched off. The parasitic elements P1 and P2 are switched off, which prevents the large current from flowing through the parasitic elements P1 and P2, and prevents overheating of the charge control circuit 10, the charge circuit and the battery connected to the charge control circuit 10.

As described above, the overheating of the charge control circuit 10, the charge circuit, and the battery caused by the reverse current generated by applying the reversed polarity voltage can be prevented by turning off the parasitic elements.

### Second Embodiment

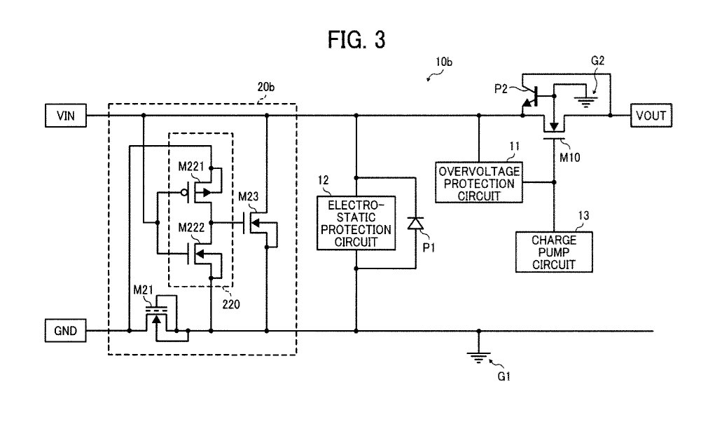

A second embodiment is described below with reference to FIG. 3. FIG. 3 is a circuit diagram illustrating a specific configuration of a charge control circuit 10b including a protection circuit 20b according to a second embodiment, corresponding to the protection circuit 20 of the first embodiment.

In the reversed polarity voltage protection circuit 20b, a current limitation element 21 is constituted by a depletion-type N-channel MOS transistor M21, the voltage detection circuit 22 is constituted by a P-channel MOS transistor M221 and an N-channel MOS transistor M222, and the conducting element 23 is constituted by an N-channel MOS transistor M23.

It is to be noted that the depletion-type N-channel MOS transistor M21 is constituted by an N-channel MOS transistor whose threshold voltage is set lower than 0 V. This depletion-type N-channel MOS transistor has characteristics that the depletion-type transistor is off even when the gate voltage relative to the source is zero.

In terms of the depletion-type N-channel MOS transistor M21, a drain is connected to the external reference terminal GND, a gate, a source, and a back-gate are connected to the internal reference potential G1. By connecting the gate and the source of the depletion-type N-channel MOS transistor M21, the gate voltage relative to the source of the depletion-type N-channel MOS transistor M21 is fixed at 0 V. Accordingly, the depletion-type N-channel MOS transistor M21 is normally on state, and at the same time, the amount of current flowing from the drain to the source of the depletion-type N-channel MOS transistor M21 is limited and is kept under a predetermined current. In addition, the N-channel MOS transistor whose gate and source are connected to each other has characteristics that the current flowing from the source to the drain as conduct state.

In terms of the P-channel MOS transistor M221, a gate thereof is connected to the power source terminal VIN and the gate of the N-channel MOS transistor M222, a source and a back-gate thereof are connected to the external reference terminal GND, and a drain thereof is connected to the drain of the N-channel MOS transistor M222 and the gate of the N-channel MOS transistor M23. The source and the back-gate of the N-channel MOS transistor M222 are connected to the first internal reference potential GI. The drain of the N-channel MOS transistor M23 is connected to the power source terminal VIN, and the source and the back-gate thereof are connected to the first internal reference potential G1. Other components have configurations similar to those in the first embodiment shown in FIG. 2.

By connecting the P-channel MOS transistor M221 and the N-channel MOS transistor M222, together functions an “inverter 220”. Herein, the “High” of the inverter 220 functions as a voltage at the external reference terminal GND, and the “Low” thereof functions as the internal reference potential G1(G2).

Next, the operation of the reversed polarity voltage protection circuit 20b is described below. When the straight polarity voltage is applied to the charge control circuit 10b, the high signal is input to the inverter 220. The inverter 220 outputs the low signal. That is, the gate voltage of the N-channel MOS transistor M23 is adjusted to the internal reference potential G1. At this time, the gate voltage and the source voltage of the N-channel MOS transistor M23 become equal, which turns the N-channel MOS transistor M23 on. Since the N-channel MOS transistor M23 is off, the reverse current from the power source terminal VIN to the external reference terminal GND does not flow through the N-channel MOS transistor M23.

On the other hand, when the straight polarity voltage is applied to the charge control circuit 10b, a backward voltage is applied to the parasitic diode P1 and to the base and emitter of the parasitic npn-type bipolar transistor P2. Therefore, these parasitic elements P1 and P2 are switched off, and the reverse current does not flow through the parasitic elements P1 and P2.

As described above, when the straight polarity voltage is applied at the power source terminal VIN, the reverse current does not flow to the power source terminal VIN, and charge is performed normally.

Conversely, when the reversed polarity voltage is applied at the power source terminal VIN, the reverse current flows to the power source terminal VIN through the parasitic diode P1 and the parasitic npn-type bipolar transistor P2. However, the amount of reverse current is limited by the depletion-type N-channel MOS transistor M21 (serving as the current limitation element 21).

As the reverse current limited by the depletion-type N-channel MOS transistor 21 flows from the external reference terminal GND to the power source terminal VIN, the internal reference potential G1(G2) declines to the potential obtained by adding the forward voltage drop across the p-n junction to the potential at the power source terminal VIN.

Accordingly, the inverter 220, constituted by the P-channel MOS transistor M221 and the N-channel MOS transistor 222, functions so that the potential at the external reference terminal GND represents as high signal, the potential at the power source terminal VIN represent as a low signal. At this time, the low signal is input to the inverter 220, and the inverter 220 outputs the high signal. That is, the gate potential of the N-channel MOS transistor M23 becomes equal to the potential at the external reference terminal GND.

By contrast, the source potential of the N-channel MOS transistor M23 is set equal to the internal reference potential G1(G2). Therefore, the gate voltage of the N-channel MOS transistor M23 relative to the source voltage thereof becomes positive, which turns the N-channel MOS transistor M23 on. By turning the N-channel MOS transistor M23 on, the potential at the power source terminal VIN and the internal reference potential G1(G2) become equal.

As the potential at the power source terminal VIN and the internal reference potential G1(G2) become equal, the parasitic diode P1 and the parasitic npn-type bipolar transistor P2 are switched off. Accordingly, a large reverse current flowing through the parasitic elements P1 and P2 are stopped.

It is to be noted that, since the actual N-channel MOS transistor M23 has an on-resistance, the potential at the power source terminal VIN and the internal reference potential G1(G2) are not completely equal. However, by using the N-channel MOS transistor M23 whose on-resistance is lower than the forward voltage drop across the p-n junction, the parasitic diode P1 and the parasitic npn-type bipolar transistor P2 are switched off.

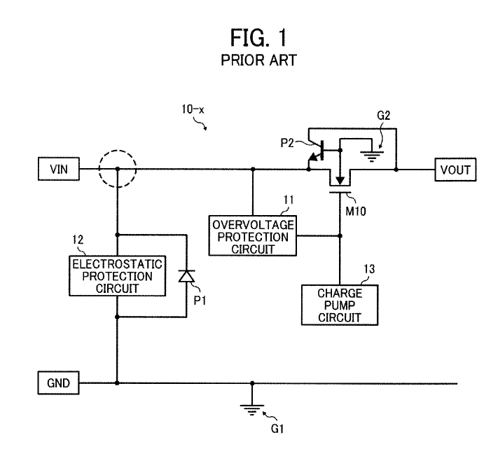

As described above, in the second embodiment, the reversed polarity voltage protection circuit 20b switches the parasitic elements P1 and P2 off when the reversed polarity voltage is applied. Accordingly, an effect similar to that of the first embodiment can be obtained. In addition, compared to the comparative example including two transistors (see the portion surrounded by the broken line shown in FIG. 1), in the present embodiment, the MOS transistors are not connected in series between the power source terminal VIN and the output terminal VOUT; and therefore, the on-resistance of the transistor during charging operation of the charge control circuit 10b is not increased.

### Third Embodiment

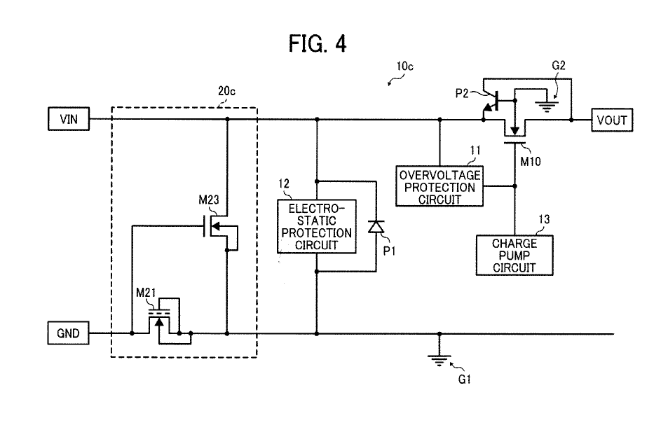

Next, a third embodiment is described below with reference to FIG. 4. FIG. 4 is a circuit diagram illustrating a specific configuration of a charge control circuit 10c including a protection circuit 20c according to the third embodiment, corresponding to the protection circuit 20 of the first embodiment.

In the reversed polarity voltage protection circuit 20c shown in FIG. 4, the current limitation element 21 is constituted by a depletion-type N-channel MOS transistor M21, and the voltage detection circuit 22 and the conducting element 23 are constituted by the N-channel MOS transistor M23.

The connection of the depletion-type N-channel MOS transistor M21 of the present embodiment is similar to the depletion-type N-channel MOS transistor M21 of the second embodiment shown in FIG. 3. The drain of the MOS transistor M23 is connected to the power source terminal VIN, and the source and the back-gate thereof are connected to the first internal reference potential G1. Other components have configurations similar to those in the first embodiment shown in FIG. 2.

Next, the operation of the reversed polarity voltage protection circuit 20c in the charge control circuit 10c is described below. When the straight polarity voltage is applied at the power source terminal VIN, the gate voltage of the N-channel MOS transistor M23 relative to the source voltage thereof is zero, the N-channel MOS transistor M23 is switched off. Since the N-channel MOS transistor M23 is switched off, the current does not flow to the N-channel MOS transistor M23. In addition, the reverse current flowing through the parasitic elements P1 and P2 are similar to the first embodiment. As described above, when the straight polarity voltage is applied at the power source terminal VIN, the reverse current does not flow to the power source terminal VIN, and the charging is normally performed.

Conversely, when the reversed polarity voltage is applied to the charge control circuit 10c, the reverse current flows from the external reference terminal GND to the power source terminal VIN through the parasitic diode P1 and the parasitic npn-type bipolar transistor P2.

Due to the reverse current flowing to the power source terminal VIN, the internal reference potential G1(G2) declines to the potential obtained by adding the forward voltage drop across the p-n junction to the potential at the power source terminal VIN. At this time, the gate voltage of the N-channel MOS transistor M23 is the potential at the external reference terminal GND. Since the gate voltage of the N-channel MOS transistor M23 relative to the source voltage thereof is positive, the N-channel MOS transistor M23 is switched on.

When the N-channel MOS transistor M23 is switched on, the potential at the power source terminal VIN and the internal reference potential G1(G2) become equal. As the al reference potential G1(G2) becomes equal to the potential at the power source terminal VIN, the parasitic diode P1 and the parasitic npn-type bipolar transistor P2 are switched of and the a large current flowing through the parasitic elements P1 and P2 are stopped. In addition, the amount of reverse current flowing through the N-channel MOS transistor M23 is limited by the depletion-type N-channel MOS transistor M21.

As described above, in the reversed polarity voltage protection circuit 20c of the third embodiment, a similar effect can be achieved. Furthermore, compared to the second embodiment, an advantage is that the circuit elements are low, and the circuit size can be small.

### Fourth Embodiment

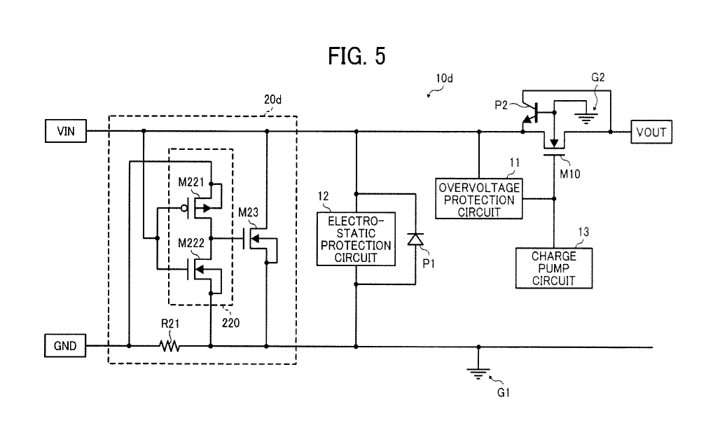

Next, a fourth embodiment is described below with reference to FIG. 5. FIG. 5 is a circuit diagram illustrating a specific configuration of a charge control circuit 10d including a protection circuit 20d according to a fourth embodiment, corresponding to the protection circuit 20 of the first embodiment.

The reversed polarity voltage protection circuit 20d includes a resistor R21 instead of the depletion-type N-channel MOS transistor M21 of the second embodiment. Other components have configurations similar to those in the second embodiment shown in FIG. 3.

Next, the operation of the reversed polarity voltage protection circuit 20d in the charge control circuit 10d is described below. When the straight polarity voltage is applied to the charge control circuit 10d, the current from the internal reference potential G1 to the external reference terminal GND flows through the resistor R21. Therefore, the relative potentials are: the potential at the power source terminal VIN>the internal reference potential GI>the potential at the external reference voltage GND.

With this potential relation, the P-channel MOS transistor M221 is switched off, and the N-channel MOS transistor M222 is switched on. The gate voltage of the N-channel MOS transistor M23 becomes equal to the internal reference potential G1. Since the gate voltage of the N-channel MOS transistor M23 relative to the source voltage is 0 V, the N-channel MOS transistor M23 is switched off. Since the N-channel MOS transistor M23 is off state, the current does not flow through the N-channel MOS transistor M23. In addition, the operation of the parasitic diode P1 and the parasitic npn-type bipolar transistor P2 when the reversed polarity voltage is applied to the charge control circuit 10d is similar to the second embodiment.

Conversely, when the reversed polarity voltage is applied to the charge control circuit 10d, the resistor R21 restricts the amount of reverse current. Other operation is similar to those in the second embodiment shown in FIG. 3. As described above, in the reversed polarity voltage protection circuit 20d of the fourth embodiment, similar effect can be obtained with the second embodiment.

### Variations

In the second through fourth embodiments, as the current limitation element 21, the depletion-type N-channel MOS transistor M21 or the resistor R21 is used, but the present disclosure is not limited above. The amount of current can be limited, using other circuit. For example, a diode can be used as the current limitation element 21.

Alternatively, the depletion-type N-channel MOS transistor M21, the resistor R21, and the diode may be used in combination. Herein, if the diode is used, a cathode of the diode is connected to the external reference terminal GND side, and an anode thereof is connected to the internal reference potential G1 side.

Yet alternatively, the current limitation element 21 may be formed by a switch, using an enhancement-type MOS transistor whose threshold is positive. However, with this configuration, when the straight polarity voltage is applied to the charge control circuit 10, the switch (enhancement-type MOS transistor) is turned on, and the internal reference potential G1 becomes equal to the potential at the external reference terminal GND. Conversely, when the reversed polarity voltage is applied to the charge control circuit 10, the switch (enhancement type MOS transistor) turned off.

In addition, the current limitation element 21 can be formed by an electrostatic protection element connected between the external reference terminal GND and the internal reference potential G1. The parasitic diode contained in the electrostatic protection element can obtain the effect similar to the diode of the current limitation element 21. In terms of the electrostatic protection element, the cathode of the parasitic diode thereof is connected to the external reference terminal side GND, and the anode thereof is connected to the internal reference potential G1.

In addition, although the inverter is used as the voltage detection circuit 22 in the second embodiment and the fourth embodiments, the present specification is not limited above. Applying the reversed polarity voltage can be detected by using the other circuits.

For example, an operational amplifier can be used. Using the operational amplifier, setting of the threshold voltage can be facilitated.

In addition, in the second through fourth embodiment, the N-channel MOS transistor M23 is used as the conducting element 23, the present specification is not limited above. Alternately, using the other circuit, the internal reference potential G1(G2) can become equal to the potential at the power source terminal VIN.

In addition, the circuit is not limited to the charge control circuit 10. The circuit configuration can be used as the other circuit through which the reverse current flows through the parasitic diode caused by applying the reversed polarity voltage.

Numerous additional modifications and variations are possible in light of the above teachings. It is therefore to be understood that, within the scope of the appended claims, the disclosure of this patent specification may be practiced otherwise than as specifically described herein.

What is claimed is:

1. A protection circuit comprising:
a current limitation element, to connect between an external reference terminal and an internal reference potential to limit the amount of current flowing from the external reference terminal to a power source terminal, when a reversed polarity voltage s applied at the power source terminal; and
a conducting element, to connect between the power source terminal and the internal reference potential to adjust the internal reference potential to the potential at the power source terminal, when the reversed polarity voltage is applied.

2. The protection circuit according to claim 1, further comprising:
a voltage detection circuit, to detect that the reversed polarity voltage whose potential is lower than a potential at the external reference terminal is applied at the power source terminal to render the conducting element conductive for dropping the internal reference potential to the potential at the power source terminal.

3. The protection circuit according to claim 2, wherein the voltage detection circuit comprises an inverter.

4. The protection circuit according to claim 3, wherein the inverter has a threshold voltage whose value is set between the potential at the external reference terminal and the internal reference potential,
wherein, when the reversed polarity voltage is applied to the power source terminal and then the internal reference potential is decreased the threshold value by limiting the amount of current flowing from the external reference terminal to the power source terminal, the inverter receives a low signal indicating the potential at the power source terminal and generates a high signal indicating the potential at the external reference terminal for output to the conducting element.

5. The protection circuit according to claim 2, wherein the voltage detection rises an operational amplifier.

6. The protection circuit according to claim 2, wherein the conducting element comprises a negative channel MOS transistor controlled by the voltage detection circuit.

7. The protection circuit according to claim 1, wherein the current limitation element comprises a depletion-type negative channel MOS transistor.

8. The protection circuit according to claim 1, wherein the current limitation element comprises a resistor.

9. The protection circuit according to claim 1, wherein the current limitation element comprises a diode.

10. A charge control circuit comprising:
a power source terminal to which a power source voltage is applied from an external power source;
an output terminal to output a current based on the power source voltage;
an external reference terminal connected to an external reference potential;
a driver transistor connected to the power source terminal, the output terminal, and an internal reference potential; and
a protection circuit to prevent a reverse current owing from the output terminal to the power source terminal,
the protection circuit comprising:
a current limitation element, to connect between the external reference terminal and the internal reference potential to limit the amount of current flowing from the external reference terminal to the power source terminal, when a reversed polarity voltage is applied at the power source terminal; and
a conducting element, to connect between the power source terminal and the internal reference potential, to adjust the internal reference potential to the potential at the power source terminal to stop parasitic operation of the driver transistor, when the reversed polarity voltage is applied.

11. The charge control circuit according to claim 10, wherein the protection circuit further comprises a voltage detection circuit to detect that the reversed polarity voltage whose potential is lower than the potential at the external reference terminal is applied at a power source terminal, to render the conducting element conductive for dropping the internal reference potential to the potential at the power source terminal.

12. The charge control circuit according to claim 11, further comprising an electrostatic protection circuit to protect the charge control circuit from ESD surge,
wherein, when the reversed polarity voltage is applied at the power source terminal,
a diode forward current generated in the electrostatic protection circuit flows from the external reference terminal to the power source terminal,
the current limitation element limits the amount of diode forward current flowing from the external reference terminal to the power source terminal, to decrease the internal reference potential to a potential obtained by adding a forward voltage drop across the p-n junction in the electrostatic protection circuit to the potential at the power source terminal,
the voltage detection circuit detects that the reversed polarity voltage is applied, based on the potential at the power source terminal, the potential at the external reference terminal, and the internal reference potential decreased to the potential obtained by adding the forward voltage drop across the p-n junction to the potential at the power source terminal,
the conducting element is rendered conductive to connect the internal reference potential with the power source terminal, to further decrease the internal reference potential to the potential at the power source terminal,
the parasitic operation of the driver transistor is stopped to prevent the reverse current from flowing from the output terminal to the power source terminal.

13. A reverse current prevention method employing a charge control circuit that has a power source terminal to which a power source voltage is applied from an external power source; an output terminal to output a current based on the power source voltage; an external reference terminal connected to an external reference potential; and a driver transistor connected between the power source terminal, the output terminal, and an internal reference potential,
the method comprising the steps of:
applying a reverse polarity voltage, whose potential is lower than a potential at the external reference terminal, at the power source terminal;
limiting the amount of current flowing from the external reference terminal to the power source terminal;
detecting that the reversed polarity voltage is applied;
connecting the internal reference potential with the power source terminal;
decreasing the internal reference potential to the potential at the power source terminal;
stopping parasitic operation of the driver transistor; and
preventing a reverse current from flowing from the output terminal to the power supply terminal through the driver transistor.

14. The reverse current prevention method according to claim 13,
the method employing the charge control Circuit that further has an electrostatic protection circuit to protect the charge control circuit from ESD surge,
the method further comprising the steps of:
applying the reversed polarity voltage at the power source terminal;
generating a diode forward current in the electrostatic protection circuit flowing from the external reference terminal to the power source terminal;
limiting the amount of diode forward current flowing from the external reference terminal to the power source terminal, to decrease the internal reference potential to a potential obtained by adding a forward voltage drop across the p-n junction in the electrostatic protection circuit to the potential at the power source terminal;
detecting that the reversed polarity voltage is applied, based on the potential at the power source terminal, the potential at the external reference terminal, and the internal reference potential decreased to the potential obtained by adding the forward voltage drop across the p-n junction to the potential at the power source terminal; and
connecting the internal reference potential with the power source terminal, to further decrease the internal reference potential to the potential at the power source terminal.
